(19) United States
(12) Patent Application Publication
(10) Pub. No.: US 2017/0028613 A1
(43) Pub. Date: Feb. 2, 2017

(54) MOLD HOLDING MECHANISM, IMPRINT APPARATUS, AND ARTICLE MANUFACTURING METHOD

(71) Applicant: CANON KABUSHIKI KAISHA, Tokyo (JP)

(72) Inventor: Tomohiro Harayama, Utsunomiya-shi (JP)

(21) Appl. No.: 15/221,644

(22) Filed: Jul. 28, 2016

(30) Foreign Application Priority Data
Jul. 29, 2015 (JP) 2015-149807

(51) Int. Cl. B29C 59/00; B29C 59/02

(52) U.S. Cl. CPC B29C 59/002; B29C 59/02; B29L 2007/001

(57) ABSTRACT

A mold holding mechanism holds a mold including a deforming portion and a support supporting the deforming portion, the deforming portion having a first surface on which a pattern to be transferred to an imprint material by imprinting is formed, and a second surface on an opposite side of the first surface, the support being held by the mold holding mechanism. The mold holding mechanism includes a space definition component defining a first space together with the second surface, the space definition component including a first flow path making the first space and a pressure controller, configured to control a pressure of the first space, communicate with each other, and a second flow path making the first space and a second space, different from the first space, communicate with each other.

### BACKGROUND OF THE INVENTION

Field of the Invention

The present invention relates to a mold holding mechanism, an imprint apparatus, and an article manufacturing method.

Description of the Related Art

An imprint technique has received attention as a lithography technique replacing a photolithography technique. The imprint technique brings a mold into contact with an imprint material supplied onto a substrate and cures the imprint material in that state, thereby forming a pattern of the imprint material on the substrate. The imprint material is, for example, a material that can be cured on the substrate like a photocuring resin or a thermosetting resin.

There is known a method of deforming a mold such that its central portion forms a convex shape toward a substrate when the mold is brought into contact with an imprint material on the substrate and also deforming the mold in the same manner when the mold is separated from the cured imprint material (see U.S. Patent Application Publication No. 2007/0114686). A mold holding mechanism holds the peripheral portion of the mold. The interior of the peripheral portion is deformed into the convex shape toward the substrate or returned to an original shape.

A mold is referred to as a template, an original, or the like. Also, respective portions of the mold are referred to as various names. In this specification, the mold includes a deforming portion and a support supporting the deforming portion, and the deforming portion has a mesa portion where a pattern to be transferred to an imprint material by imprinting is formed, a detail of which will be described anew.

From time at which the mold contacts the imprint material on the substrate to time at which the mold is separated from the cured imprint material, the mesa portion of the deforming portion can vibrate together with a substrate holding mechanism holding the substrate, and the support can vibrate together with the mold holding mechanism. Therefore, a relative vibration of the mesa portion with respect to the support can be generated in the mold. If such a relative vibration becomes excessive, a mark and the pattern formed in the mesa portion are deformed. This may be a cause of decreasing an alignment accuracy or damaging the mold.

### SUMMARY OF THE INVENTION

The present invention provides a technique advantageous in reducing a relative vibration in a mold.

One of aspects of the present invention provides a mold holding mechanism for holding a mold, the mold including a deforming portion and a support supporting the deforming portion, the deforming portion having a first surface on which a pattern to be transferred to an imprint material by imprinting is formed, and a second surface on an opposite side of the first surface, the support being held by the mold holding mechanism, wherein the mold holding mechanism includes a space definition component defining a first space together with the second surface, the space definition component including a first flow path making the first space and a pressure controller, configured to control a pressure of the first space, communicate with each other, and a second flow path making the first space and a second space, different from the first space, communicate with each other.

Further features of the present invention will become apparent from the following description of exemplary embodiments with reference to the attached drawings.

### BRIEF DESCRIPTION OF THE DRAWINGS

FIG. 1 is a view showing the schematic arrangement of an imprint apparatus according to one embodiment of the present invention;

FIGS. 2A and 2B are views each schematically showing the sectional shape of a mold;

FIG. 3 is a view schematically showing a mold holding mechanism in a comparative example;

FIGS. 4A and 4B are views schematically showing a mold holding mechanism according to the first embodiment;

FIG. 5 is a view schematically showing a mold holding mechanism according to the second embodiment;

FIG. 6 is a view schematically showing the mold holding mechanism according to the second embodiment; and

FIGS. 7A and 7B are graphs each exemplifying a damping characteristic of a relative vibration of a mesa portion with respect to a support in a mold.

### DESCRIPTION OF THE EMBODIMENTS

Exemplary embodiments of the present invention will be described below with reference to the accompanying drawings.

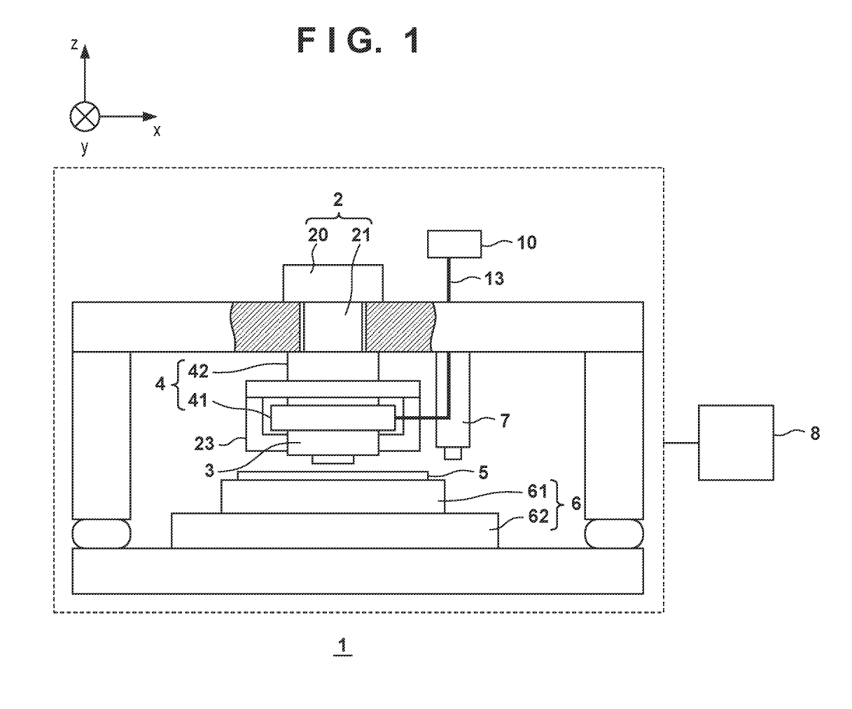

FIG. 1 shows the schematic arrangement of an imprint apparatus 1 according to one embodiment of the present invention. The imprint apparatus 1 is configured to bring a mold 3 into contact with an imprint material on a substrate 5 and cure the imprint material.

In this specification and the accompanying drawings, directions are shown in an X-Y-Z coordinate system in which directions parallel to the surface of the substrate 5 form an X-Y plane. Let the X direction, the Y direction, and the Z direction be the directions parallel to the X-axis, the Y-axis, and the Z-axis, respectively, in the X-Y-Z coordinate system. Let θX, θY, and θZ, respectively, be rotation about the X-axis, rotation about the Y-axis, and rotation about the Z-axis. Control or driving regarding the X-axis, the Y-axis, and the Z-axis means control or driving regarding the direction parallel to the X-axis, the direction parallel to the Y-axis, and the direction parallel to the Z-axis, respectively. Further, control or driving regarding the θX-axis, the θY-axis, and the θZ-axis means control or driving regarding rotation about an axis parallel to the X-axis, rotation about an axis parallel to the Y-axis, and rotation about an axis parallel to the Z-axis, respectively.

The imprint apparatus 1 can include a mold operation mechanism 4 operating the mold 3, a substrate operation mechanism 6 operating the substrate 5, a dispenser 7 supplying the imprint material onto the substrate 5, a curing unit (curing energy supply) 2 curing the imprint material on the substrate 5, and a controller 8. In addition, the imprint apparatus 1 can include a shape correction mechanism 23 correcting the shape of the mold 3, a pressure regulator 10 (a pressure controller) configured to deform the mold 3 such that its deforming portion forms a convex shape toward the substrate 5, and a connecting portion 13 connecting the pressure regulator 10 and the mold operation mechanism 4.

The mold operation mechanism 4 can include a mold holding mechanism 41 holding the mold 3 and a mold driving mechanism 42 driving the mold holding mechanism 41 so as to drive the mold 3 with respect to a plurality of axes (for example, six axes of the X-axis, the Y-axis, the Z-axis, the θX-axis, the θY-axis, and the θZ-axis). The substrate operation mechanism 6 can include a substrate holding mechanism 61 holding the substrate 5 and a substrate driving mechanism 62 driving the substrate holding mechanism 61 so as to drive the substrate 5 with respect to a plurality of axes (for example, three axes of the X-axis, the Y-axis, and the θZ-axis).

At least one of the mold operation mechanism 4 and the substrate operation mechanism 6 can bring the mold 3 and the imprint material on the substrate 5 into contact with and separate them from each other. Typically, the mold 3 and the imprint material on the substrate 5 can be brought into contact with and separated from each other by driving the mold 3 in the Z direction with the mold operation mechanism 4.

The imprint apparatus 1 can include the first measurement device measuring the position and the rotation of the mold 3 or the mold holding mechanism 41, the second measurement device measuring the position and the rotation of the substrate 5 or the substrate holding mechanism 61, and the third measurement device measuring the relative positions and rotations of the mold 3 and the substrate 5. Each of the first measurement device and the second measurement device can include, for example, a laser interferometer or an encoder. The third measurement device can include a scope measuring the relative positions of a mark of the mold 3 and a mark of the substrate 5.

Control of the mold 3 and the substrate 5 by the controller 8 can include the first control and the second control. In the first control, the controller 8 feedback-controls the mold driving mechanism 42 based on a measurement result by the first measurement device and also feedback-controls the substrate driving mechanism 62 based on a measurement result by the second measurement device. In the second control, the controller 8 feedback-controls at least one of the mold driving mechanism 42 and the substrate driving mechanism 62 based on a measurement result by the third measurement device. In one example, the positions and the rotations of the mold 3 and the substrate 5 can be controlled by the first control until all or a part of a mesa portion of the mold 3 is brought into contact with the imprint material on the substrate 5 and after the mesa portion of the mold 3 is separated from the cured imprint material. The positions and the rotations of the mold 3 and the substrate 5 can be controlled by the second control in a state in which all or the part of the mesa portion of the mold 3 is in contact with the imprint material on the substrate 5.

The dispenser 7 supplies the imprint material onto the substrate 5. The imprint material is, for example, a material that can be cured on the substrate 5 like a photocuring resin or a thermosetting resin. The dispenser 7 can include, for example, a plurality of orifices each discharging the uncured imprint material. In one example, the controller 8 causes the dispenser 7 to discharge the imprint material while causing the substrate operation mechanism 6 to scan the substrate 5 such that the imprint material is supplied to a shot region of the substrate 5.

The curing unit 2 supplies, to the imprint material, energy for curing the imprint material in a state in which the mold 3 is in contact with the imprint material. When the imprint material is a photocuring material such as the photocuring resin, the curing unit 2 can be configured to irradiate the imprint material with light in the state in which the mold 3 is in contact with the imprint material. When the imprint material is a thermosetting material such as the thermosetting resin, the curing unit 2 can be configured to supply heat to the imprint material in the state in which the mold 3 is in contact with the imprint material.

The curing unit 2 can include, for example, an energy source 20 and a relay 21 configured to supply energy generated by the energy source 20 to the substrate 5. When the imprint material is the photocuring material such as the photocuring resin, the energy source 20 can be a light source, and the relay 21 can be an optical system. The optical system can include, for example, an aperture defining a region to be irradiated with light, a shutter controlling irradiation and non-irradiation of light, and an optical element such as a lens or a mirror. When the imprint material is the thermosetting material such as the thermosetting resin, the energy source 20 can be a heat source, and the relay 21 can be a heat transmission unit.

The shape correction mechanism 23 deforms the mold 3 into an arbitrary shape by applying forces to a plurality of portions on the side surface of the mold 3 with a plurality of actuators. The shape correction mechanism 23 can be understood as a part of the arrangement of the mold holding mechanism 41 or a component separate from the mold holding mechanism 41.

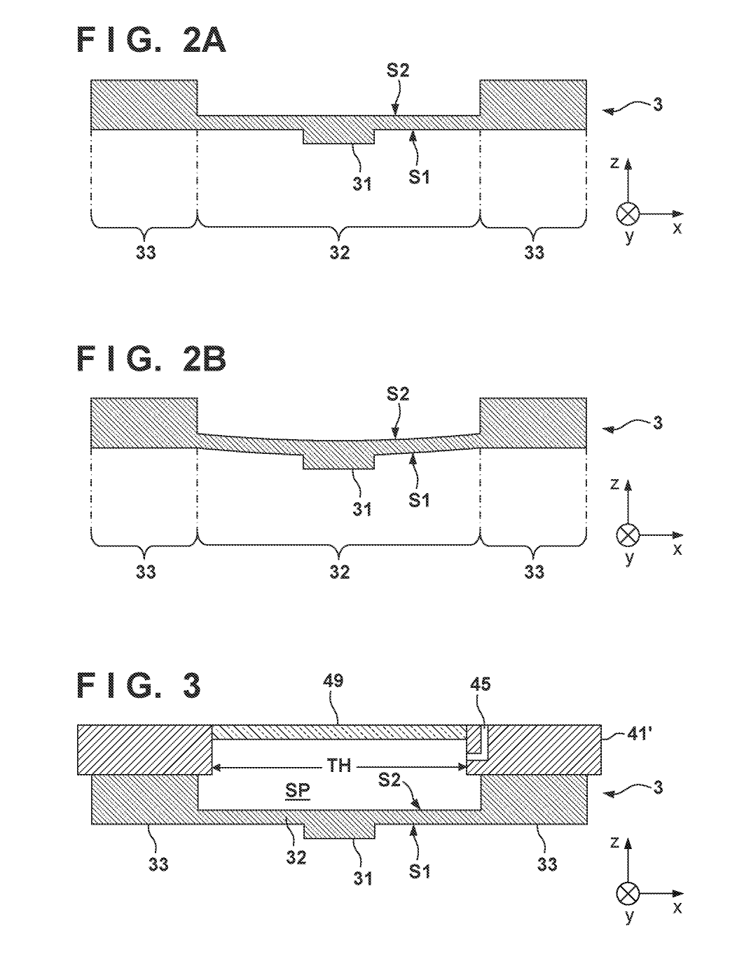

Each of FIGS. 2A and 2B schematically shows the sectional shape of the mold 3. FIG. 2A shows the sectional shape of the mold 3 in a state in which no force is applied to the mold 3. FIG. 2B shows the sectional shape of the mold 3 in a state in which a force is applied to the mold 3 such that its deforming portion forms the convex shape toward the substrate. The mold 3 includes a deforming portion (diaphragm) 32 and a support 33 supporting the deforming portion 32. Typically, the deforming portion 32 is the central portion of the mold 3, and the support 33 is the peripheral portion of the mold 3. Typically, the support 33 has a shape surrounding the deforming portion 32 through the perimeter. The deforming portion 32 has a first surface S1 having a mesa portion 31 where a pattern to be transferred to the imprint material by imprinting is formed and a second surface S2 on the opposite side of the first surface S1. The mold holding mechanism 41 holds the support 33.

A space is formed on the side of the second surface S2. The shape of the mold 3 can be controlled by controlling a pressure of that space with the pressure regulator 10. If the pressure of the space is increased, the deforming portion 32 is bulged so as to form the convex shape toward the substrate, as schematically shown in FIG. 2B. If the pressure of the space is returned to the original pressure, the deforming portion 32 returns to a neutral state. Paying attention to such an action, the deforming portion 32 operates like the diaphragm.

The pattern to be transferred to the imprint material on the substrate by imprinting is made by a trench and formed in the mesa portion 31. The curing unit 2 supplies energy in a state in which the trench formed in the mesa portion 31 is filled with the imprint material, thereby curing the imprint material and forming the pattern corresponding to the trench of the mesa portion 31 on the substrate.

The mold holding mechanism 41 will be described below. However, a mold holding mechanism 41′ of a comparative example will be described with reference to FIG. 3 before describing the mold holding mechanism 41 in the embodiment of the present invention. The mold holding mechanism 41′ holds a mold 3 by chucking a support 33 of the mold 3. The mold holding mechanism 41′ has a through hole TH making energy (for example, light) for curing the imprint material pass and a window portion (for example, a glass member) 49 provided in the through hole TH. A space SP is formed between the window portion 49 and a second surface S2 of a deforming portion 32 in the mold 3. This space SP is referred to as a cavity space. The mold holding mechanism 41′ includes a flow path 45 for connecting the space SP and a pressure regulator 10 via a connecting portion 13.

The pressure regulator 10 deforms the mold 3 by controlling a pressure of the space SP through the flow path 45. More specifically, the mold 3 is deformed such that its deforming portion 32 forms a convex shape on a substrate side by regulating, with the pressure regulator 10, the pressure of the space SP (a pressure on the side of the second surface S2) to be higher than a pressure on the side of a first surface S1. The mold 3 is deformed such that its deforming portion 32 forms a concave shape on the substrate side by regulating, with the pressure regulator 10, the pressure of the space SP (the pressure on the side of the second surface S2) to be lower than the pressure on the side of a first surface S1. The shape of the mold 3 is set in a neutral state by regulating, with the pressure regulator 10, the pressure of the space SP (the pressure on the side of the second surface S2) to be equal to the pressure on the side of the first surface S1.

When starting to bring the mold 3 (more particularly, a mesa portion 31) into contact with an imprint material supplied onto a substrate 5 by a dispenser 7, the pressure regulator 10 applies a pressure to the space SP, and the deforming portion 32 of the mold 3 is deformed into the convex shape toward the substrate 5. At this time, a state is typically obtained in which the central portion of the mesa portion 31 protrudes the most. This brings the center portion of the mesa portion 31 in the mold 3 into first contact with the imprint material on the substrate 5. Then, the contact area between the imprint material on the substrate 5 and the mesa portion 31 (mold pattern) is increased. With such a contact method, entering of bubbles (remaining of a gas) between the mesa portion 31 and the imprint material can be reduced.

When the mesa portion 31 contacts the imprint material on the substrate 5, the mesa portion 31 is coupled to the substrate 5 firmly via the imprint material. On the other hand, the mold holding mechanism 41′ holds the support 33. The substrate 5 is positioned by a substrate operation mechanism 6. The mold 3 is positioned by a mold operation mechanism 4. Relative vibrations also exist between a substrate holding mechanism 61 and a mold holding mechanism 41 in the first control and the second control described above. Therefore, the mesa portion 31 vibrates relatively to the support 33. In one example, the substrate holding mechanism 61 may be supported by an air bearing and have almost no damping characteristic. In such an arrangement, a vibration generated when the mesa portion 31 contacts the imprint material on the substrate 5 is unlikely to be damped.

When the mesa portion 31 vibrates relatively to the support 33, a mark and a pattern provided in the mesa portion 31 may be deformed, decreasing an alignment accuracy and an overlay accuracy. Further, when the mesa portion 31 vibrates relatively to the support 33, the mold 3 may cause a brittle fracture. Therefore, the relative vibration of the mesa portion 31 with respect to the support 33 should be suppressed rapidly.

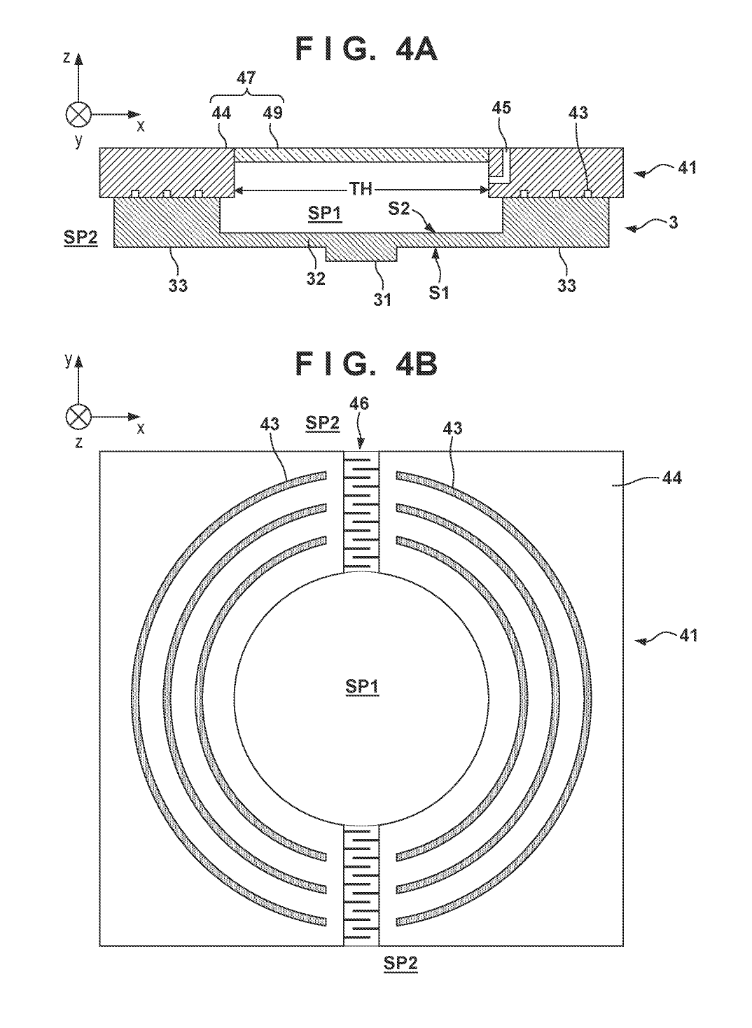

The arrangement of a mold holding mechanism 41 according to the first embodiment of the present invention will be described below with reference to FIGS. 4A and 4B. The mold holding mechanism 41 of the first embodiment is advantageous in reducing the relative vibration of the mesa portion 31 described above rapidly. FIG. 4A is a sectional view showing the mold holding mechanism 41 holding a mold 3. FIG. 4B is a view showing the lower surface of the mold holding mechanism 41.

The mold holding mechanism 41 includes chucking units 43 holding a support 33 of the mold 3. The chucking units 43 hold the mold 3 by, for example, a chucking method such as vacuum chucking or electrostatic chucking. The mold holding mechanism 41 includes a space definition component 47 defining a first space SP1 (cavity space) together with a second surface S2 of the mold 3. The second surface S2 of the mold 3 faces the first space SP1. A first surface S1 of the mold 3 faces a second space SP2.

The mold holding mechanism 41 includes a first flow path 45 for connecting the first space SP1 and a pressure regulator 10 via a connecting portion 13. The pressure regulator 10 deforms the mold 3 by controlling a pressure of the first space SP1 through the first flow path 45. More specifically, the mold 3 is deformed such that its deforming portion 32 forms a convex shape on a substrate side by regulating, with the pressure regulator 10, the pressure of the first space SP1 (a pressure on the side of the second surface S2) to be higher than a pressure on the side of the first surface S1. The mold 3 is deformed such that its deforming portion 32 forms a concave shape on the substrate side by regulating, with the pressure regulator 10, the pressure of the first space SP1 (the pressure on the side of the second surface S2) to be lower than the pressure on the side of a first surface S1. The shape of the mold 3 is set in a neutral state by regulating, with the pressure regulator 10, the pressure of the first space SP1 (the pressure on the side of the second surface S2) to be equal to the pressure on the side of the first surface S1.

The space definition component 47 can include, for example, a holder 44 holding the support 33 of the mold 3 and a window portion 49. The holder 44 can include a through hole TH and the chucking units 43. The window portion 49 is provided so as to close the through hole TH. The window portion 49 makes energy (for example, light) generated by a curing unit 2 pass in order to cure an imprint material such that the energy is supplied to the imprint material on the substrate. A part of the first space SP1 can be defined by the inner surface of the through hole TH. Another part of the first space SP1 can be defined by the inner surface of the window portion 49. Still another part of the first space SP1 can be defined by the inner surface of the support 33 in the mold 3. The space definition component 47 includes the first flow path 45 making the first space SP1 and the pressure regulator 10, configured to regulate or control the pressure of the first space SP1, communicate with each other, and a second flow path 46 making the first space SP1 and the second space SP2, different from the first space SP1, communicate with each other.

The relative vibration of the deforming portion 32 with respect to the support 33 changes the volume of the first space SP1. Along with this change, a gas moves between the first space SP1 and the second space SP2 through the second flow path 46. The second flow path 46 makes a viscosity resistance act on movement of the gas between the first space SP1 and the second space SP2. This damps the relative vibration of the deforming portion 32 with respect to the support 33.

The second flow path 46 meanders, for example, so as to form a labyrinth. Making the second flow path 46 meander is effective in adjusting the viscosity resistance and conductance of the second flow path 46. Making the second flow path 46 meander is also effective in preventing a particle from entering the first space SP1. The conductance of the second flow path 46 is preferably lower than the conductance of the flow path 45 for regulating the pressure of the first space SP1 (in other words, the shape of the deforming portion 32). The second flow path 46 can be formed by, for example, forming a trench in a holding surface where the holder 44 holds the mold 3, that is, a surface where the chucking units 43 are arranged.

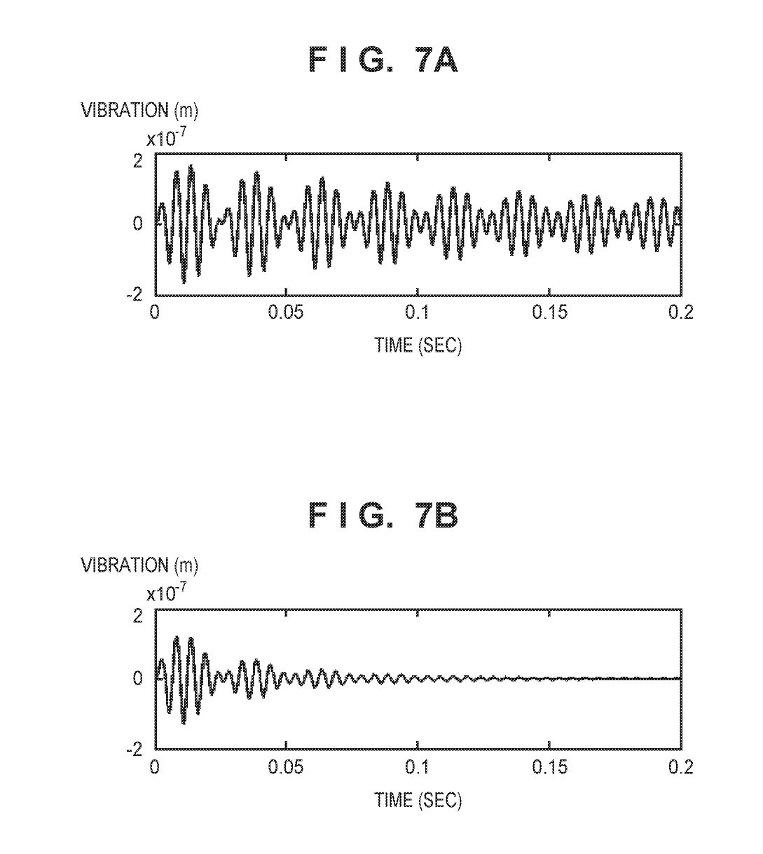

FIG. 7A shows a Z-direction vibration (the relative vibration with respect to the support 33) of the mesa portion 31 in the mold 3 held by the mold holding mechanism 41′ in the comparative example shown in FIG. 3. FIG. 7B shows the Z-direction vibration (the relative vibration with respect to the support 33) of the mesa portion 31 in the mold 3 held by the mold holding mechanism 41 in the first embodiment shown in FIGS. 4A and 4B. Each of FIGS. 7A and 7B shows the vibration generated when the mesa portion 31 of the mold 3 whose support 33 is held by the substrate holding mechanism contacts the imprint material on the substrate 5. The abscissa represents a time, and the ordinate represents the relative vibration of the mesa portion 31 with respect to the support 33. It is found that the relative vibration of the mesa portion 31 with respect to the support 33 is damped faster in the first embodiment than in the comparative example.

According to the first embodiment, it is therefore possible to damp the relative vibration of the mesa portion 31 with respect to the support 33 effectively. This makes it possible to suppress deformations in the mark and the pattern provided in the mesa portion 31, and the decreases in the alignment accuracy and the overlay accuracy caused by the deformations. It is also possible to suppress the brittle fracture by the mold 3.

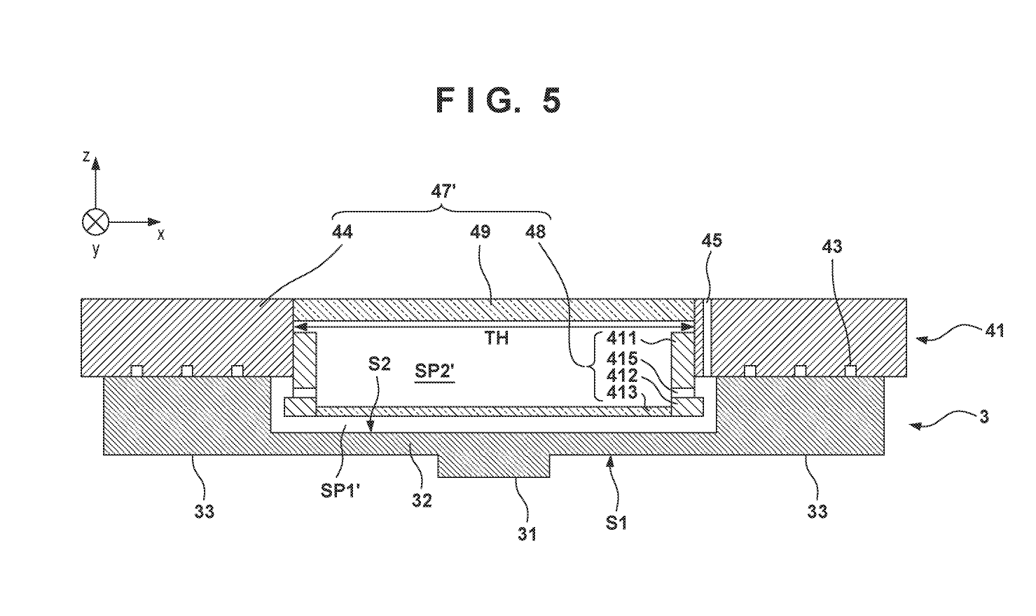

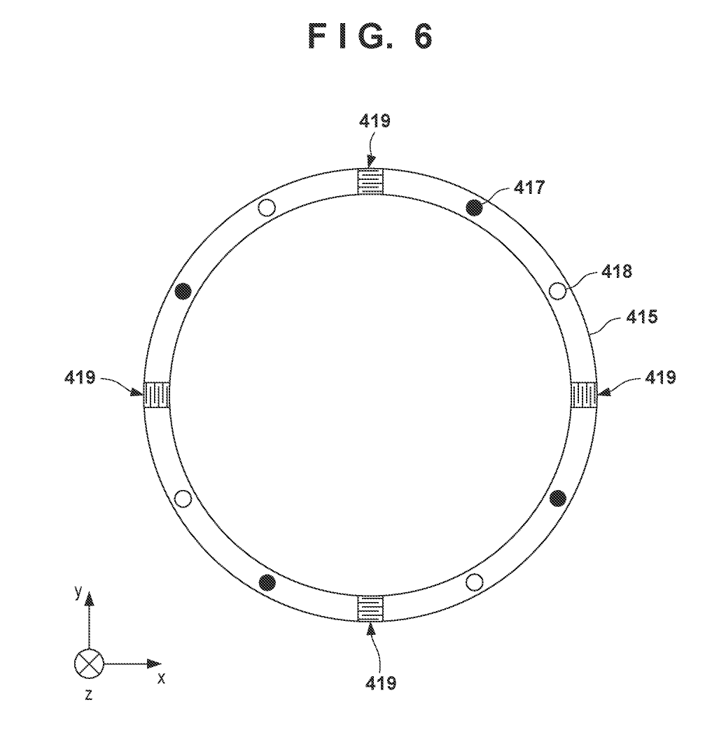

The arrangement of a mold holding mechanism 41 according to the second embodiment of the present invention will be described below with reference to FIGS. 5 and 6. Matters that are not mentioned in the second embodiment can comply with the first embodiment. The mold holding mechanism 41 of the second embodiment is also advantageous in reducing a relative vibration of a mesa portion 31 rapidly. FIG. 5 is a sectional view showing the mold holding mechanism 41 holding a mold 3. FIG. 6 shows the arrangement of a connecting member 415 as a component of the mold holding mechanism 41.

The mold holding mechanism 41 includes chucking units 43 holding a support 33 of the mold 3. The chucking units 43 hold the mold 3 by, for example, a chucking method such as vacuum chucking or electrostatic chucking. The mold holding mechanism 41 includes a space definition component 47′ defining at least a part of a second space SP2′ as well as a part of a first space SP1′ (cavity space). A second surface S2 of the mold 3 faces the first space SP1′. The second space SP2′ is formed between, for example, the first space SP1′ and a window portion 49.

The mold holding mechanism 41 includes a first flow path 45 for connecting the first space SP1′ and a pressure regulator 10 via a connecting portion 13. The pressure regulator 10 deforms the mold 3 by controlling a pressure of the first space SP1′ through the first flow path 45. More specifically, the mold 3 is deformed such that its deforming portion 32 forms a convex shape on a substrate side by regulating, with the pressure regulator 10, the pressure of the first space SP1′ (a pressure on the side of the second surface S2) to be higher than a pressure on the side of a first surface S1. The mold 3 is deformed such that its deforming portion 32 forms a concave shape on the substrate side by regulating, with the pressure regulator 10, the pressure of the first space SP1′ (the pressure on the side of the second surface S2) to be lower than the pressure on the side of the first surface S1. The shape of the mold 3 is set in a neutral state by regulating, with the pressure regulator 10, the pressure of the first space SP1′ (the pressure on the side of the second surface S2) to be equal to the pressure on the side of the first surface S1.

The space definition component 47′ can be configured to make energy for curing an imprint material on the substrate pass through the second space SP2′. The space definition component 47′ can include a structure 48 defining the part of the second space SP2′ as well as the part of the first space SP1′. The structure 48 includes second flow paths 419 making the first space SP1′ and the second space SP2′ communicate with each other.

The structure 48 can include, for example, a first tabular member 411, a second tabular member 412, a connecting member 415, and a window portion 413. The mold holding mechanism 41 includes a holder 44 holding the support 33 of the mold 3. The holder 44 can have a through hole TH. The structure 48 can be configured to define the part of the second space SP2′ inside the through hole TH. The window portion 413 makes energy (for example, light) generated by a curing unit 2 pass in order to cure the imprint material such that the energy is supplied to the imprint material on the substrate. The space definition component 47′ may be configured such that the holder 44 defines the part of the first space SP1′. When the curing unit 2 is arranged outside the first space SP1′, the space definition component 47′ further includes the window portion 49. The window portion 49 makes energy (for example, light) generated by the curing unit 2 pass in order to cure the imprint material such that the energy is supplied to the imprint material on the substrate. The structure 48 can be configured to define the first space SP1′ between the second space SP2′ and the second surface S2 of the mold 3.

The first tabular member 411 and the second tabular member 412 can have tabular shapes and be connected to each other via the connecting member 415. In addition to the cylindrical shape, for example, a shape having a sectional shape such as an ellipse or a polygon falls under the category of the tabular shape. FIG. 6 shows an example of the arrangement of the preferred connecting member 415 when each of the first tabular member 411 and the second tabular member 412 has the cylindrical shape. The connecting member 415 has holes 417 for fastening the first tabular member 411 and the connecting member 415 to each other by fastener components (typically, bolts), and holes 418 for fastening the second tabular member 412 and the connecting member 415 to each other by fastener components (typically, bolts). The connecting member 415 also includes the second flow paths 419 making the first space SP1′ and the second space SP2′ communicate with each other. The second flow paths 419 meander, for example, so as to form a labyrinth. The second flow paths 419 may be provided in at least one of the first tabular member 411, the second tabular member 412, and the window portion 413.

The first space SP1′ and the second space SP2′ communicate with each other by the second flow paths 419. Thus, the flow path 45 may be arranged so as to communicate with the second space SP2′ such that the pressure of the first space SP1′ is controlled by controlling the pressure of the second space SP2′. In this case, however, responsiveness of pressure control in the first space SP1′ may be decreased. It is therefore preferable that the flow path 45 directly communicates with the first space SP1′ in order to improve responsiveness of deformation control of the deforming portion 32 by the pressure regulator 10.

As schematically shown in FIG. 5, the volume of the first space SP1′ is preferably smaller than that of the second space SP2′. An arrangement in which the volume of the first space SP1′ is smaller than that of the second space SP2′ is advantageous in increasing sensitivity of a pressure fluctuation in the first space SP1′ to the vibration of the mesa portion 31. This pressure fluctuation causes movement of a gas passing through the second flow paths 419. This gas movement is influenced by a viscosity resistance in the second flow paths 419. This viscosity resistance acts so as to damp the relative vibration of the mesa portion 31 with respect to the support 33.

Therefore, a damping effect on the relative vibration of the mesa portion 31 with respect to the support 33 is higher in the second embodiment than in the first embodiment. Accordingly, an effect of suppressing decreases in an alignment accuracy and an overlay accuracy, and an effect of suppressing a brittle fracture by the mold 3 are higher in the second embodiment than in the first embodiment.

A manufacturing method of a device (a semiconductor integrated circuit device, a liquid crystal display device, or the like) as an article includes a step of forming a pattern on a substrate (a wafer, a glass plate, or a film-like substrate) by using the above-described imprint apparatus. The manufacturing method can also include a step of processing (for example, etching) the substrate onto which the pattern has been formed. Note that when manufacturing another article such as a patterned media (storage medium) or an optical element, the manufacturing method can include, instead of etching, another process of processing the substrate onto which the pattern has been formed. The article manufacturing method according to this embodiment is advantageous in at least one of the performance, the quality, the productivity, and the production cost of the article, as compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-149807, filed Jul. 29, 2015, which is hereby incorporated by reference herein in its entirety.

What is claimed is:

1. A mold holding mechanism for holding a mold, the mold including a deforming portion and a support supporting the deforming portion, the deforming portion having a first surface on which a pattern to be transferred to an imprint material by imprinting is formed, and a second surface on an opposite side of the first surface, the support being held by the mold holding mechanism,
wherein the mold holding mechanism includes a space definition component defining a first space together with the second surface, the space definition component including a first flow path making the first space and a pressure controller, configured to control a pressure of the first space, communicate with each other, and a second flow path making the first space and a second space, different from the first space, communicate with each other.

2. The mechanism according to claim 1, wherein the second flow path meanders.

3. The mechanism according to claim 1, wherein a conductance of the second flow path is lower than a conductance of the first flow path.

4. The mechanism according to claim 1, wherein the first surface faces the second space.

5. The mechanism according to claim 1, wherein the space definition component includes a holder holding the support of the mold, the holder having a through hole making energy for curing the imprint material pass, a part of the first space being defined by an inner surface of the through hole.

6. The mechanism according to claim 1, wherein the space definition component includes a structure defining at least a part of the second space as well as a part of the first space.

7. The mechanism according to claim 6, wherein the space definition component includes a holder holding the support of the mold, the holder having a through hole,
wherein the structure defines the part of the second space inside the through hole, and the structure defines the first space between the second space and a second surface of the mold.

8. The mechanism according to claim 7, wherein the space definition component is configured to make energy for curing the imprint material pass through the second space.

9. The mechanism according to claim 7, wherein the second flow path is provided in the structure.

10. The mechanism according to claim 1, wherein a volume of the first space is smaller than a volume of the second space.

11. An imprint apparatus which brings a mold into contact with an imprint material on a substrate and cures the imprint material, the apparatus comprising:
a mold holding mechanism configured to hold a mold,
wherein the mold includes a deforming portion and a support supporting the deforming portion, the deforming portion having a first surface on which a pattern to be transferred to an imprint material by imprinting is formed, and a second surface on an opposite side of the first surface, the support being held by the mold holding mechanism,
wherein the mold holding mechanism includes a space definition component defining a first space together with the second surface, the space definition component including a first flow path making the first space and a pressure controller, configured to control a pressure of the first space, communicate with each other, and a second flow path making the first space and a second space, different from the first space, communicate with each other.

12. An imprint apparatus which brings a mold into contact with an imprint material on a substrate and cures the imprint material, comprising:
a substrate holding mechanism configured to hold the substrate;
a mold holding mechanism configured to hold the mold; and
a pressure controller,
wherein the mold includes a deforming portion and a support supporting the deforming portion, the deforming portion having a first surface on which a pattern to be transferred to an imprint material by imprinting is formed, and a second surface on an opposite side of the first surface,
wherein the mold holding mechanism includes a space definition component defining a first space together with the second surface, the space definition component including a first flow path making the first space and the pressure controller communicate with each other, and a second flow path making the first space and a second space different from the first space communicate with each other, and
wherein deformation in the deforming portion is adjusted by regulating, with the pressure controller, a pressure of the first space through the first flow path.

13. An article manufacturing method of manufacturing an article, the method comprising:
forming a pattern on a substrate by using an imprint apparatus which brings a mold into contact with an imprint material on the substrate and cures the imprint material; and
processing the substrate on which the pattern has been formed,
wherein the imprint apparatus includes a mold holding mechanism holding the mold,
the mold including a deforming portion and a support supporting the deforming portion, the deforming portion having a first surface on which a pattern to be transferred to an imprint material by imprinting is formed, and a second surface on an opposite side of the first surface, the support being held by the mold holding mechanism,
wherein the mold holding mechanism includes a space definition component defining a first space together with the second surface, the space definition component including a first flow path making the first space and a pressure controller, configured to control a pressure of the first space, communicate with each other, and a second flow path making the first space and a second space, different from the first space, communicate with each other.

14. An article manufacturing method of manufacturing an article, the method comprising:
forming a pattern on a substrate by using an imprint apparatus which brings a mold into contact with an imprint material on the substrate and cures the imprint material; and
processing the substrate on which the pattern has been formed,
wherein the imprint apparatus comprising:
a substrate holding mechanism configured to hold the substrate;
a mold holding mechanism configured to hold the mold; and
a pressure controller,
wherein the mold includes a deforming portion and a support supporting the deforming portion, the deforming portion having a first surface on which a pattern to be transferred to an imprint material by imprinting is formed, and a second surface on an opposite side of the first surface,
wherein the mold holding mechanism includes a space definition component defining a first space together with the second surface, the space definition component including a first flow path making the first space and the pressure controller communicate with each other, and a second flow path making the first space and a second space different from the first space communicate with each other, and
wherein deformation in the deforming portion is adjusted by regulating, with the pressure controller, a pressure of the first space through the first flow path.
